(19) United States
(12) Patent Application Publication
(10) Pub. No.: US 2024/0241616 A1
(43) Pub. Date: Jul. 18, 2024

(54) Method And Device For Navigating Windows In 3D

(71) Applicant: DATHOMIR LABORATORIES LLC, Boston, MA (US)

(72) Inventors: Shih-Sang Chiu, Menlo Park, CA (US); Benjamin H. Boesel, Sunnyvale, CA (US); David H. Huang, San Mateo, CA (US); Jonathan Perron, Felton, CA (US); Jonathan Ravasz, Sunnyvale, CA (US); Jordan A. Cazamias, San Francisco, CA (US); Tyson Erze, Felton, CA (US)

(21) Appl. No.: 18/562,957

(22) PCT Filed: May 11, 2022
(86) PCT No.: PCT/US2022/028702

§ 371 Date: Nov. 21, 2023

Related U.S. Application Data
(60) Provisional application No. 63/195,772, filed on Jun. 2, 2021.

(51) Int. Cl. G06F 3/04815; G06F 3/01; G06F 3/04845; G06F 3/16; G06T 19/00

(52) U.S. Cl. CPC G06F 3/04815; G06F 3/013; G06F 3/04845; G06T 19/006; G06F 3/167; G06F 2203/04804; G06T 2200/24

(57) ABSTRACT

In one implementation, a method for navigating windows in 3D. The method includes: displaying a first content pane with a first appearance at a first z-depth within an extended reality (XR) environment, wherein the first content pane includes first content and an input field; detecting a user input directed to the input field; and, in response to detecting the user input directed to the input field: moving the content first pane to a second z-depth within the XR environment, wherein the second z-depth is different from the first z-depth; modifying the first content pane by changing the first content pane from the first appearance to a second appearance; and displaying a second content pane with the first appearance at the first z-depth within the XR environment.

### TECHNICAL FIELD

The present disclosure generally relates to navigating windows and, in particular, to systems, methods, and methods for navigating windows in 3D.

### BACKGROUND

Current web browsers may use a tab arrangement for open web pages and also provide a means for viewing browsing history. This organization structure makes it difficult to concurrently view past and present web pages and/or searches.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating architecture in accordance with some implementations.

FIG. 2 is a block diagram of an example controller in accordance with some implementations.

FIG. 3 is a block diagram of an example electronic device in accordance with some implementations.

FIG. 4A is a block diagram of an example content delivery architecture in accordance with some implementations.

FIG. 4B illustrates an example data structures in accordance with some implementations.

FIGS. 5A-5H illustrate a sequence of instances for a content navigation scenario in accordance with some implementations.

FIG. 6 is a flowchart representation of a method of navigating windows in 3D inputs in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for navigating windows in 3D. According to some implementations, the method is performed at a computing system including non-transitory memory and one or more processors, wherein the computing system is communicatively coupled to a display device and one or more input devices. The method includes: displaying a first content pane with a first appearance at a first z-depth within an extended reality (XR) environment, wherein the first content pane includes first content and an input field: detecting a user input directed to the input field: and, in response to detecting the user input: moving the first content pane to a second z-depth within the XR environment, wherein the second z-depth is different from the first z-depth; modifying the first content pane by changing the first content pane from the first appearance to a second appearance: and displaying a second content pane with the first appearance at the first z-depth within the XR environment.

In accordance with some implementations, an electronic device includes one or more displays, one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more displays, one or more processors, a non-transitory memory, and means for performing or causing performance of any of the methods described herein.

In accordance with some implementations, a computing system includes one or more processors, non-transitory memory, an interface for communicating with a display device and one or more input devices, and one or more programs: the one or more programs are stored in the non-transitory memory and configured to be executed by the one or more processors and the one or more programs include instructions for performing or causing performance of the operations of any of the methods described herein. In accordance with some implementations, a non-transitory computer readable storage medium has stored therein instructions which when executed by one or more processors of a computing system with an interface for communicating with a display device and one or more input devices, cause the computing system to perform or cause performance of the operations of any of the methods described herein. In accordance with some implementations, a computing system includes one or more processors, non-transitory memory, an interface for communicating with a display device and one or more input devices, and means for performing or causing performance of the operations of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, μLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

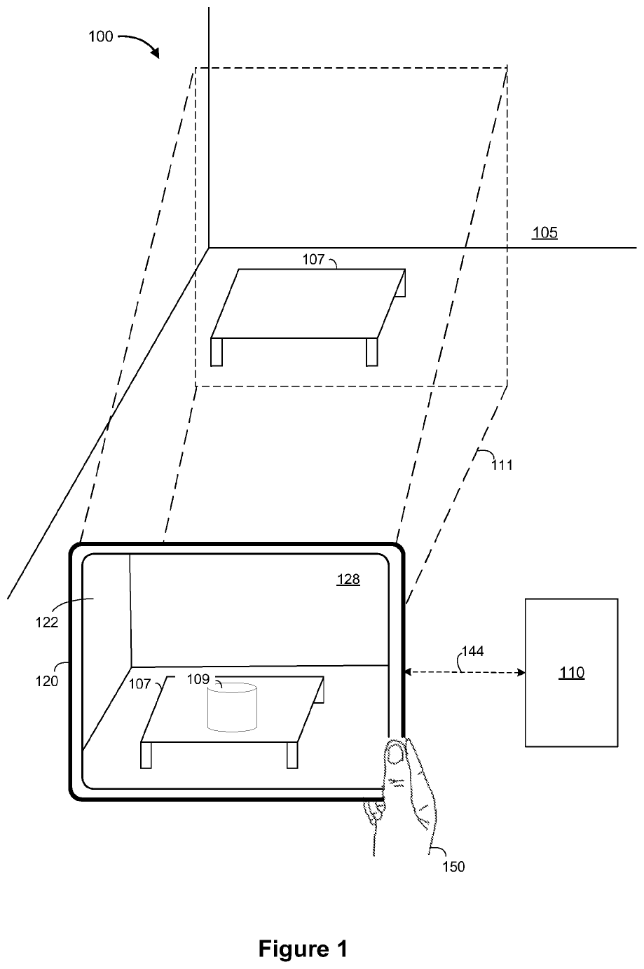

FIG. 1 is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes an optional controller 110 and an electronic device 120 (e.g., a tablet, mobile phone, laptop, near-eye system, wearable computing device, or the like).

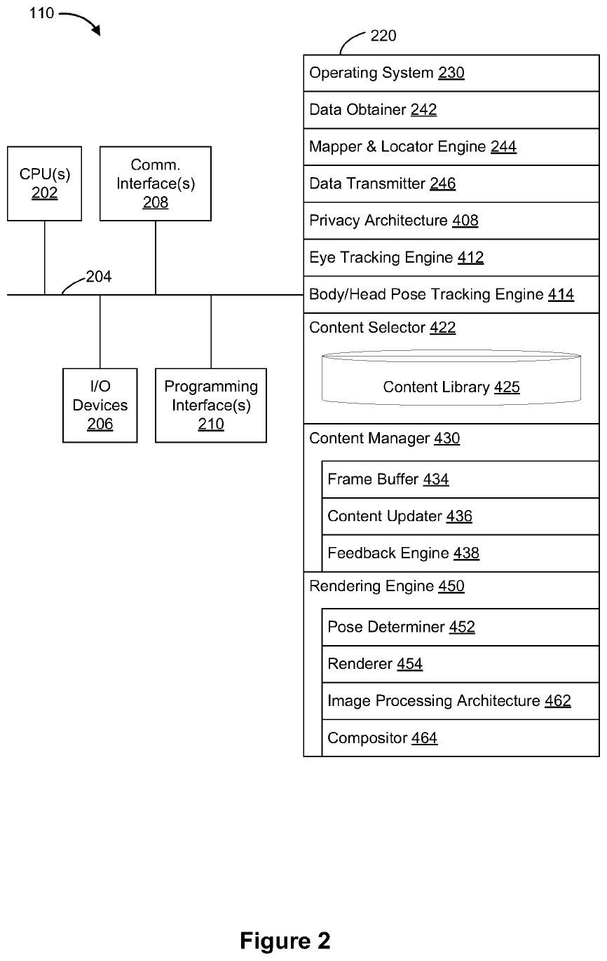

In some implementations, the controller 110 is configured to manage and coordinate an XR experience (sometimes also referred to herein as a “XR environment” or a “virtual environment” or a “graphical environment”) for a user 150 and optionally other users. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In some implementations, the functions of the controller 110 are provided by the electronic device 120. As such, in some implementations, the components of the controller 110 are integrated into the electronic device 120.

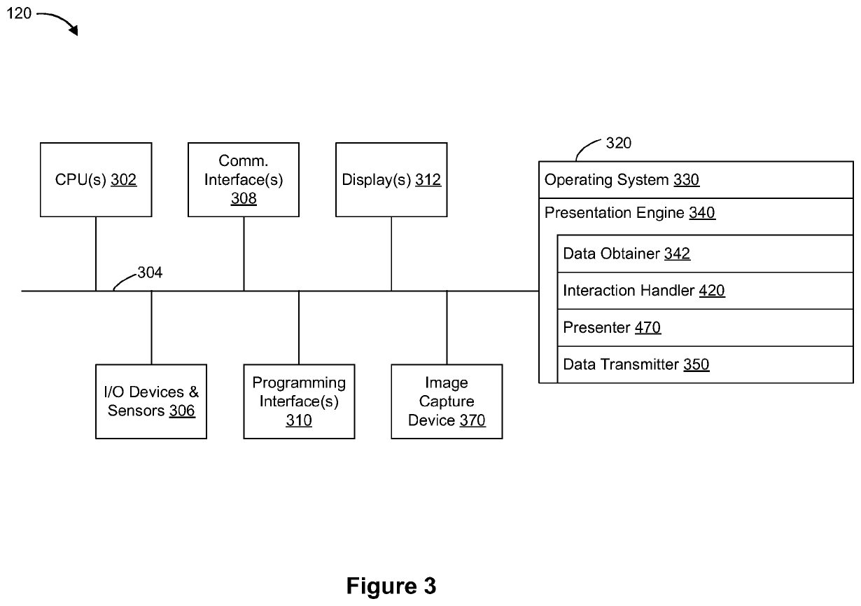

In some implementations, the electronic device 120 is configured to present audio and/or video (A/V) content to the user 150. In some implementations, the electronic device 120 is configured to present a user interface (UI) and/or an XR environment 128 to the user 150. In some implementations, the electronic device 120 includes a suitable combination of software, firmware, and/or hardware. The electronic device 120 is described in greater detail below with respect to FIG. 3.

According to some implementations, the electronic device 120 presents an XR experience to the user 150 while the user 150 is physically present within a physical environment 105 that includes a table 107 within the field-of-view (FOV) 111 of the electronic device 120. As such, in some implementations, the user 150 holds the electronic device 120 in his/her hand(s). In some implementations, while presenting the XR experience, the electronic device 120 is configured to present XR content (sometimes also referred to herein as “graphical content” or “virtual content”), including an XR cylinder 109, and to enable video pass-through of the physical environment 105 (e.g., including the table 107) on a display 122. For example, the XR environment 128, including the XR cylinder 109, is volumetric or three-dimensional (3D).

In one example, the XR cylinder 109 corresponds to display-locked content such that the XR cylinder 109 remains displayed at the same location on the display 122 as the FOV 111 changes due to translational and/or rotational movement of the electronic device 120. As another example, the XR cylinder 109 corresponds to world-locked content such that the XR cylinder 109 remains displayed at its origin location as the FOV 111 changes due to translational and/or rotational movement of the electronic device 120. As such, in this example, if the FOV 111 does not include the origin location, the XR environment 128 will not include the XR cylinder 109. For example, the electronic device 120 corresponds to a near-eye system, mobile phone, tablet, laptop, wearable computing device, or the like.

In some implementations, the display 122 corresponds to an additive display that enables optical see-through of the physical environment 105 including the table 107. For example, the display 122 corresponds to a transparent lens, and the electronic device 120 corresponds to a pair of glasses worn by the user 150. As such, in some implementations, the electronic device 120 presents a user interface by projecting the XR content (e.g., the XR cylinder 109) onto the additive display, which is, in turn, overlaid on the physical environment 105 from the perspective of the user 150. In some implementations, the electronic device 120 presents the user interface by displaying the XR content (e.g., the XR cylinder 109) on the additive display, which is, in turn, overlaid on the physical environment 105 from the perspective of the user 150.

In some implementations, the user 150 wears the electronic device 120 such as a near-eye system. As such, the electronic device 120 includes one or more displays provided to display the XR content (e.g., a single display or one for each eye). For example, the electronic device 120 encloses the FOV of the user 150. In such implementations, the electronic device 120 presents the XR environment 128 by displaying data corresponding to the XR environment 128 on the one or more displays or by projecting data corresponding to the XR environment 128 onto the retinas of the user 150.

In some implementations, the electronic device 120 includes an integrated display (e.g., a built-in display) that displays the XR environment 128. In some implementations, the electronic device 120 includes a head-mountable enclosure. In various implementations, the head-mountable enclosure includes an attachment region to which another device with a display can be attached. For example, in some implementations, the electronic device 120 can be attached to the head-mountable enclosure. In various implementations, the head-mountable enclosure is shaped to form a receptacle for receiving another device that includes a display (e.g., the electronic device 120). For example, in some implementations, the electronic device 120 slides/snaps into or otherwise attaches to the head-mountable enclosure. In some implementations, the display of the device attached to the head-mountable enclosure presents (e.g., displays) the XR environment 128. In some implementations, the electronic device 120 is replaced with an XR chamber, enclosure, or room configured to present XR content in which the user 150 does not wear the electronic device 120.

In some implementations, the controller 110 and/or the electronic device 120 cause an XR representation of the user 150 to move within the XR environment 128 based on movement information (e.g., body pose data, eye tracking data, hand/limb/finger/extremity tracking data, etc.) from the electronic device 120 and/or optional remote input devices within the physical environment 105. In some implementations, the optional remote input devices correspond to fixed or movable sensory equipment within the physical environment 105 (e.g., image sensors, depth sensors, infrared (IR) sensors, event cameras, microphones, etc.). In some implementations, each of the remote input devices is configured to collect/capture input data and provide the input data to the controller 110 and/or the electronic device 120 while the user 150 is physically within the physical environment 105. In some implementations, the remote input devices include microphones, and the input data includes audio data associated with the user 150 (e.g., speech samples). In some implementations, the remote input devices include image sensors (e.g., cameras), and the input data includes images of the user 150. In some implementations, the input data characterizes body poses of the user 150 at different times. In some implementations, the input data characterizes head poses of the user 150 at different times. In some implementations, the input data characterizes hand tracking information associated with the hands of the user 150 at different times. In some implementations, the input data characterizes the velocity and/or acceleration of body parts of the user 150 such as his/her hands. In some implementations, the input data indicates joint positions and/or joint orientations of the user 150. In some implementations, the remote input devices include feedback devices such as speakers, lights, or the like.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a touchscreen, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof described below with respect to FIG. 2.

The operating system 230 includes procedures for handling various basic system services and for performing hardware dependent tasks.

In some implementations, a data obtainer 242 is configured to obtain data (e.g., captured image frames of the physical environment 105, presentation data, input data, user interaction data, camera pose tracking information, eye tracking information, head/body pose tracking information, hand/limb/finger/extremity tracking information, sensor data, location data, etc.) from at least one of the I/O devices 206 of the controller 110, the I/O devices and sensors 306 of the electronic device 120, and the optional remote input devices. To that end, in various implementations, the data obtainer 242 includes instructions and/or logic therefor, and heuristics and metadata therefor.

In some implementations, a mapper and locator engine 244 is configured to map the physical environment 105 and to track the position/location of at least the electronic device 120 or the user 150 with respect to the physical environment 105. To that end, in various implementations, the mapper and locator engine 244 includes instructions and/or logic therefor, and heuristics and metadata therefor.

In some implementations, a data transmitter 246 is configured to transmit data (e.g., presentation data such as rendered image frames associated with the XR environment, location data, etc.) to at least the electronic device 120 and optionally one or more other devices. To that end, in various implementations, the data transmitter 246 includes instructions and/or logic therefor, and heuristics and metadata therefor.

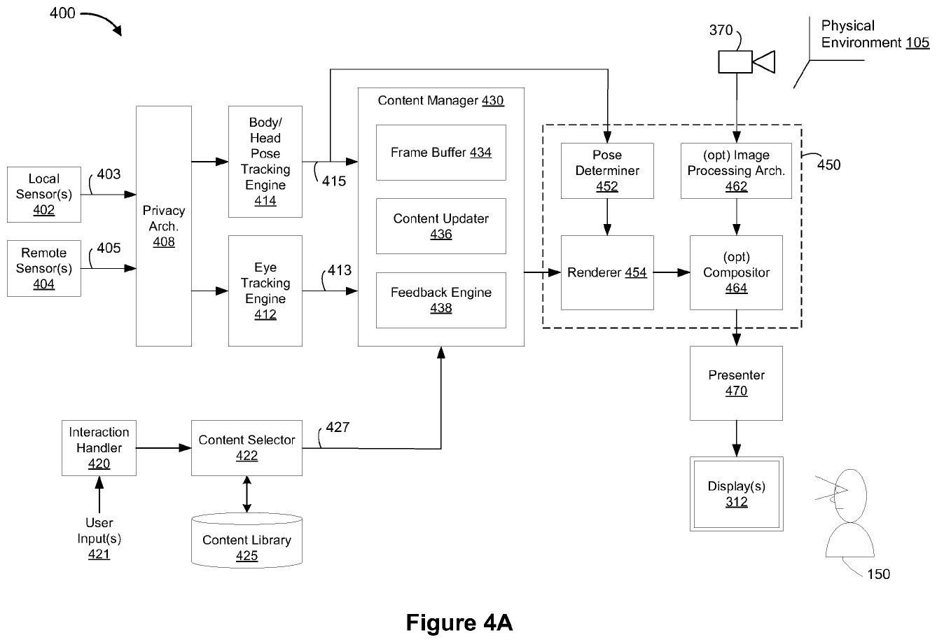

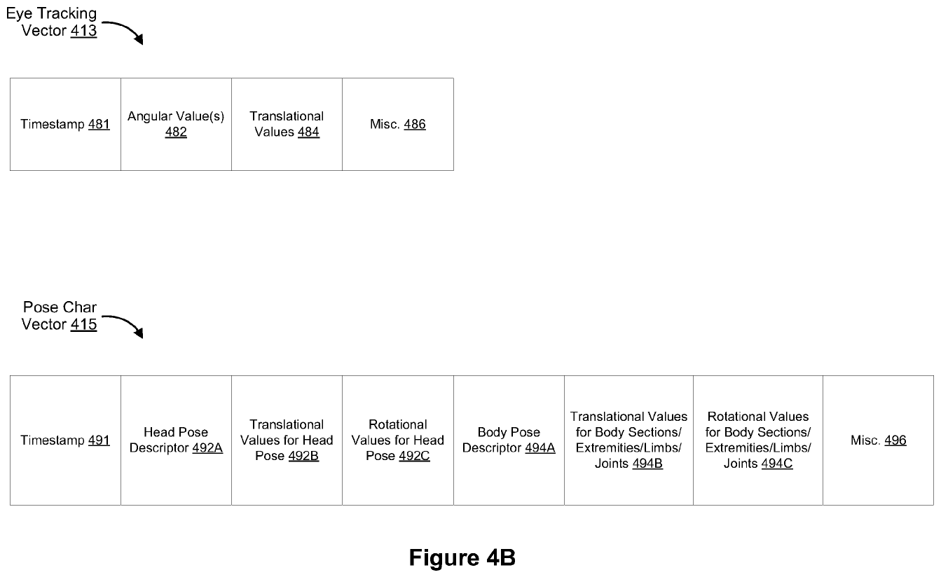

In some implementations, a privacy architecture 408 is configured to ingest input data and filter user information and/or identifying information within the input data based on one or more privacy filters. The privacy architecture 408 is described in more detail below with reference to FIG. 4A. To that end, in various implementations, the privacy architecture 408 includes instructions and/or logic therefor, and heuristics and metadata therefor.

In some implementations, an eye tracking engine 412 is configured to determine an eye tracking vector 413 (e.g., with a gaze direction) based on the input data and update the eye tracking vector 413 over time as shown in FIGS. 4A and 4B. For example, the gaze direction indicates a point (e.g., associated with x, y, and z coordinates relative to the physical environment 105 or the world at-large), a physical object, or a region of interest (ROI) in the physical environment 105 at which the user 150 is currently looking. As another example, the gaze direction indicates a point (e.g., associated with x, y, and z coordinates relative to the XR environment 128), an XR object, or a region of interest (ROI) in the XR environment 128 at which the user 150 is currently looking. The eye tracking engine 412 is described in more detail below with reference to FIG. 4A. To that end, in various implementations, the eye tracking engine 412 includes instructions and/or logic therefor, and heuristics and metadata therefor.

In some implementations, a body/head pose tracking engine 414 is configured to determine a pose characterization vector 415 based on the input data and update the pose characterization vector 415 over time. For example, as shown in FIG. 4B, the pose characterization vector 415 includes a head pose descriptor 492A (e.g., upward, downward, neutral, etc.), translational values for the head pose 492B, rotational values for the head pose 492C, a body pose descriptor 494A (e.g., standing, sitting, prone, etc.), translational values for body sections/extremities/limbs/joints 494B, rotational values for the body sections/extremities/limbs/joints 494C, and/or the like. The body/head pose tracking engine 414 is described in more detail below with reference to FIG. 4A. To that end, in various implementations, the body/head pose tracking engine 414 includes instructions and/or logic therefor, and heuristics and metadata therefor. In some implementations, the eye tracking engine 412 and the body/head pose tracking engine 414 may be located on the electronic device 120 in addition to or in place of the controller 110.

In some implementations, a content selector 422 is configured to select XR content (sometimes also referred to herein as “graphical content” or “virtual content”) from a content library 425 based on one or more user requests and/or inputs (e.g., a voice command, a selection from a user interface (UI) menu of XR content items, and/or the like). The content selector 422 is described in more detail below with reference to FIG. 4A. To that end, in various implementations, the content selector 422 includes instructions and/or logic therefor, and heuristics and metadata therefor.

In some implementations, the content library 425 includes a plurality of content items such as audio/visual (A/V) content, virtual agents (VAs), and/or XR content, objects, items, scenery, etc. As one example, the XR content includes 3D reconstructions of user captured videos, movies, TV episodes, and/or other XR content. In some implementations, the content library 425 is pre-populated or manually authored by the user 150. In some implementations, the content library 425 is located local relative to the controller 110. In some implementations, the content library 425 is located remote from the controller 110 (e.g., at a remote server, a cloud server, or the like).

In some implementations, a content manager 430 is configured to manage and update the layout, setup, structure, and/or the like for the XR environment 128 including one or more of VA(s), XR content, one or more user interface (UI) elements associated with the XR content, and/or the like. The content manager 430 is described in more detail below with reference to FIG. 4A. To that end, in various implementations, the content manager 430) includes instructions and/or logic therefor, and heuristics and metadata therefor. In some implementations, the content manager 430) includes a frame buffer 434, a content updater 436, and a feedback engine 438. In some implementations, the frame buffer 434 includes XR content, a rendered image frame, and/or the like for one or more past instances and/or frames.

In some implementations, the content updater 436 is configured to modify the XR environment 128 over time based on translational or rotational movement, user commands, user inputs, and/or the like. To that end, in various implementations, the content updater 436 includes instructions and/or logic therefor, and heuristics and metadata therefor.

In some implementations, the feedback engine 438 is configured to generate sensory feedback (e.g., visual feedback such as text or lighting changes, audio feedback, haptic feedback, etc.) associated with the XR environment 128. To that end, in various implementations, the feedback engine 438 includes instructions and/or logic therefor, and heuristics and metadata therefor.

In some implementations, a rendering engine 450) is configured to render an XR environment 128 (sometimes also referred to herein as a “graphical environment” or “virtual environment”) or image frame associated therewith as well as the VA(s), XR content, one or more UI elements associated with the XR content, and/or the like. To that end, in various implementations, the rendering engine 450 includes instructions and/or logic therefor, and heuristics and metadata therefor. In some implementations, the rendering engine 450) includes a pose determiner 452, a renderer 454, an optional image processing architecture 462, and an optional compositor 464. One of ordinary skill in the art will appreciate that the optional image processing architecture 462 and the optional compositor 464 may be present for video pass-through configuration but may be removed for fully VR or optical see-through configurations.

In some implementations, the pose determiner 452 is configured to determine a current camera pose of the electronic device 120 and/or the user 150 relative to the A/V content and/or XR content. The pose determiner 452 is described in more detail below with reference to FIG. 4A. To that end, in various implementations, the pose determiner 452 includes instructions and/or logic therefor, and heuristics and metadata therefor.

In some implementations, the renderer 454 is configured to render the A/V content and/or the XR content according to the current camera pose relative thereto. The renderer 454 is described in more detail below with reference to FIG. 4A. To that end, in various implementations, the renderer 454 includes instructions and/or logic therefor, and heuristics and metadata therefor.

In some implementations, the image processing architecture 462 is configured to obtain (e.g., receive, retrieve, or capture) an image stream including one or more images of the physical environment 105 from the current camera pose of the electronic device 120 and/or the user 150. In some implementations, the image processing architecture 462 is also configured to perform one or more image processing operations on the image stream such as warping, color correction, gamma correction, sharpening, noise reduction, white balance, and/or the like. The image processing architecture 462 is described in more detail below with reference to FIG. 4A. To that end, in various implementations, the image processing architecture 462 includes instructions and/or logic therefor, and heuristics and metadata therefor.

In some implementations, the compositor 464 is configured to composite the rendered A/V content and/or XR content with the processed image stream of the physical environment 105 from the image processing architecture 462 to produce rendered image frames of the XR environment 128 for display. The compositor 464 is described in more detail below with reference to FIG. 4A. To that end, in various implementations, the compositor 464 includes instructions and/or logic therefor, and heuristics and metadata therefor.

Although the data obtainer 242, the mapper and locator engine 244, the data transmitter 246, the privacy architecture 408, the eye tracking engine 412, the body/head pose tracking engine 414, the content selector 422, the content manager 430, and the rendering engine 450 are shown as residing on a single device (e.g., the controller 110), it should be understood that in other implementations, any combination of the data obtainer 242, the mapper and locator engine 244, the data transmitter 246, the privacy architecture 408, the eye tracking engine 412, the body/head pose tracking engine 414, the content selector 422, the content manager 430, and the rendering engine 450 may be located in separate computing devices.

In some implementations, the functions and/or components of the controller 110 are combined with or provided by the electronic device 120 shown below in FIG. 3. Moreover, FIG. 2 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 (e.g., a mobile phone, tablet, laptop, near-eye system, wearable computing device, or the like) in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, an image capture device 370 (e.g., one or more optional interior- and/or exterior-facing image sensors), a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a magnetometer, a thermometer, one or more physiological sensors (e.g., blood pressure monitor, heart rate monitor, blood oximetry monitor, blood glucose monitor, etc.), one or more microphones, one or more speakers, a haptics engine, a heating and/or cooling unit, a skin shear engine, one or more depth sensors (e.g., structured light, time-of-flight, LiDAR, or the like), a localization and mapping engine, an eye tracking engine, a body/head pose tracking engine, a hand/limb/finger/extremity tracking engine, a camera pose tracking engine, or the like.

In some implementations, the one or more displays 312 are configured to present the XR environment to the user. In some implementations, the one or more displays 312 are also configured to present flat video content to the user (e.g., a 2-dimensional or “flat” AVI, FLV, WMV, MOV, MP4, or the like file associated with a TV episode or a movie, or live video pass-through of the physical environment 105). In some implementations, the one or more displays 312 correspond to touchscreen displays. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. For example, the electronic device 120 includes a single display. In another example, the electronic device 120 includes a display for each eye of the user. In some implementations, the one or more displays 312 are capable of presenting AR and VR content. In some implementations, the one or more displays 312 are capable of presenting AR or VR content.

In some implementations, the image capture device 370 correspond to one or more RGB cameras (e.g., with a complementary metal-oxide-semiconductor (CMOS) image sensor or a charge-coupled device (CCD) image sensor), IR image sensors, event-based cameras, and/or the like. In some implementations, the image capture device 370 includes a lens assembly, a photodiode, and a front-end architecture. In some implementations, the image capture device 370 includes exterior-facing and/or interior-facing image sensors.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and a presentation engine 340.

The operating system 330 includes procedures for handling various basic system services and for performing hardware dependent tasks. In some implementations, the presentation engine 340 is configured to present media items and/or XR content to the user via the one or more displays 312. To that end, in various implementations, the presentation engine 340 includes a data obtainer 342, a presenter 470, an interaction handler 420, and a data transmitter 350.

In some implementations, the data obtainer 342 is configured to obtain data (e.g., presentation data such as rendered image frames associated with the user interface or the XR environment, input data, user interaction data, head tracking information, camera pose tracking information, eye tracking information, hand/limb/finger/extremity tracking information, sensor data, location data, etc.) from at least one of the I/O devices and sensors 306 of the electronic device 120, the controller 110, and the remote input devices. To that end, in various implementations, the data obtainer 342 includes instructions and/or logic therefor, and heuristics and metadata therefor.

In some implementations, the interaction handler 420 is configured to detect user interactions with the presented A/V content and/or XR content (e.g., gestural inputs detected via hand tracking, eye gaze inputs detected via eye tracking, voice commands, etc.). To that end, in various implementations, the interaction handler 420 includes instructions and/or logic therefor, and heuristics and metadata therefor.

In some implementations, the presenter 470 is configured to present and update A/V content and/or XR content (e.g., the rendered image frames associated with the user interface or the XR environment 128 including the VA(s), the XR content, one or more UI elements associated with the XR content, and/or the like) via the one or more displays 312. To that end, in various implementations, the presenter 470 includes instructions and/or logic therefor, and heuristics and metadata therefor.

In some implementations, the data transmitter 350 is configured to transmit data (e.g., presentation data, location data, user interaction data, head tracking information, camera pose tracking information, eye tracking information, hand/limb/finger/extremity tracking information, etc.) to at least the controller 110. To that end, in various implementations, the data transmitter 350 includes instructions and/or logic therefor, and heuristics and metadata therefor.

Although the data obtainer 342, the interaction handler 420, the presenter 470, and the data transmitter 350 are shown as residing on a single device (e.g., the electronic device 120), it should be understood that in other implementations, any combination of the data obtainer 342, the interaction handler 420, the presenter 470, and the data transmitter 350 may be located in separate computing devices.

Moreover, FIG. 3 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 4A is a block diagram of an example content delivery architecture 400 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the content delivery architecture 400 is included in a computing system such as the controller 110 shown in FIGS. 1 and 2: the electronic device 120 shown in FIGS. 1 and 3; and/or a suitable combination thereof.

As shown in FIG. 4A, one or more local sensors 402 of the controller 110, the electronic device 120, and/or a combination thereof obtain local sensor data 403 associated with the physical environment 105. For example, the local sensor data 403 includes images or a stream thereof of the physical environment 105, simultaneous location and mapping (SLAM) information for the physical environment 105 and the location of the electronic device 120 or the user 150 relative to the physical environment 105, ambient lighting information for the physical environment 105, ambient audio information for the physical environment 105, acoustic information for the physical environment 105, dimensional information for the physical environment 105, semantic labels for objects within the physical environment 105, and/or the like. In some implementations, the local sensor data 403 includes un-processed or post-processed information.

Similarly, as shown in FIG. 4A, one or more remote sensors 404 associated with the optional remote input devices within the physical environment 105 obtain remote sensor data 405 associated with the physical environment 105. For example, the remote sensor data 405 includes images or a stream thereof of the physical environment 105, SLAM information for the physical environment 105 and the location of the electronic device 120 or the user 150 relative to the physical environment 105, ambient lighting information for the physical environment 105, ambient audio information for the physical environment 105, acoustic information for the physical environment 105, dimensional information for the physical environment 105, semantic labels for objects within the physical environment 105, and/or the like. In some implementations, the remote sensor data 405 includes un-processed or post-processed information.

According to some implementations, the privacy architecture 408 ingests the local sensor data 403 and the remote sensor data 405. In some implementations, the privacy architecture 408 includes one or more privacy filters associated with user information and/or identifying information. In some implementations, the privacy architecture 408 includes an opt-in feature where the electronic device 120 informs the user 150 as to what user information and/or identifying information is being monitored and how the user information and/or the identifying information will be used. In some implementations, the privacy architecture 408 selectively prevents and/or limits content delivery architecture 400 or portions thereof from obtaining and/or transmitting the user information. To this end, the privacy architecture 408 receives user preferences and/or selections from the user 150 in response to prompting the user 150 for the same. In some implementations, the privacy architecture 408 prevents the content delivery architecture 400 from obtaining and/or transmitting the user information unless and until the privacy architecture 408 obtains informed consent from the user 150. In some implementations, the privacy architecture 408 anonymizes (e.g., scrambles, obscures, encrypts, and/or the like) certain types of user information. For example, the privacy architecture 408 receives user inputs designating which types of user information the privacy architecture 408 anonymizes. As another example, the privacy architecture 408 anonymizes certain types of user information likely to include sensitive and/or identifying information, independent of user designation (e.g., automatically).

According to some implementations, the eye tracking engine 412 obtains the local sensor data 403 and the remote sensor data 405 after it has been subjected to the privacy architecture 408. In some implementations, the eye tracking engine 412 determines an eye tracking vector 413 based on the input data and updates the eye tracking vector 413 over time.

FIG. 4B shows an example data structure for the eye tracking vector 413 in accordance with some implementations. As shown in FIG. 4B, the eye tracking vector 413 may correspond to an N-tuple characterization vector or characterization tensor that includes a timestamp 481 (e.g., the most recent time the eye tracking vector 413 was updated), one or more angular values 482 for a current gaze direction (e.g., roll, pitch, and yaw values), one or more translational values 484 for the current gaze direction (e.g., x, y, and z values relative to the physical environment 105, the world, and/or the like), and/or miscellaneous information 486. One of ordinary skill in the art will appreciate that the data structure for the eye tracking vector 413 in FIG. 4B is merely an example that may include different information portions in various other implementations and be structured in myriad ways in various other implementations.

For example, the gaze direction indicates a point (e.g., associated with x, y, and z coordinates relative to the physical environment 105 or the world at-large), a physical object, or a region of interest (ROI) in the physical environment 105 at which the user 150 is currently looking. As another example, the gaze direction indicates a point (e.g., associated with x, y, and z coordinates relative to the XR environment 128), an XR object, or a region of interest (ROI) in the XR environment 128 at which the user 150 is currently looking.

According to some implementations, the body/head pose tracking engine 414 obtains the local sensor data 403 and the remote sensor data 405 after it has been subjected to the privacy architecture 408. In some implementations, the body/head pose tracking engine 414 determines a pose characterization vector 415 based on the input data and updates the pose characterization vector 415 over time.

FIG. 4B shows an example data structure for the pose characterization vector 415 in accordance with some implementations. As shown in FIG. 4B, the pose characterization vector 415 may correspond to an N-tuple characterization vector or characterization tensor that includes a timestamp 491 (e.g., the most recent time the pose characterization vector 415 was updated), a head pose descriptor 492A (e.g., upward, downward, neutral, etc.), translational values for the head pose 492B, rotational values for the head pose 492C, a body pose descriptor 494A (e.g., standing, sitting, prone, etc.), translational values for body sections/extremities/limbs/joints 494B, rotational values for the body sections/extremities/limbs/joints 494C, and/or miscellaneous information 496. In some implementations, the pose characterization vector 413 also includes information associated with hand/extremity tracking. One of ordinary skill in the art will appreciate that the data structure for the pose characterization vector 415 in FIG. 4B is merely an example that may include different information portions in various other implementations and be structured in myriad ways in various other implementations.

According to some implementations, the interaction handler 420 obtains (e.g., receives, retrieves, or detects) one or more user inputs 421 provided by the user 150 that are associated with selecting A/V content, one or more VAs, and/or XR content for presentation. For example, the one or more user inputs 421 correspond to a gestural input selecting XR content from a UI menu detected via hand/extremity tracking, an eye gaze input selecting XR content from the UI menu detected via eye tracking, a voice command selecting XR content from the UI menu detected via a microphone, and/or the like. In some implementations, the content selector 422 selects XR content 427 from the content library 425 based on one or more user inputs 421 (e.g., a voice command, a selection from a menu of XR content items, and/or the like).

In various implementations, the content manager 430 manages and updates the layout, setup, structure, and/or the like for the XR environment 128 including one or more of VAs, XR content, one or more UI elements associated with the XR content, and/or the like. To that end, the content manager 430 includes the frame buffer 434, the content updater 436, and the feedback engine 438.

In some implementations, the frame buffer 434 includes XR content, a rendered image frame, and/or the like for one or more past instances and/or frames. In some implementations, the content updater 436 modifies the XR environment 128 over time based on the eye tracking vector 413, the pose characterization vector 415, user inputs 421 associated with modifying and/or manipulating the XR content or VA(s), translational or rotational movement of objects within the physical environment 105, translational or rotational movement of the electronic device 120 (or the user 150), and/or the like. In some implementations, the feedback engine 438 generates sensory feedback (e.g., visual feedback such as text or lighting changes, audio feedback, haptic feedback, etc.) associated with the XR environment 128.

According to some implementations, the pose determiner 452 determines a current camera pose of the electronic device 120 and/or the user 150 relative to the XR environment 128 and/or the physical environment 105 based at least in part on the pose characterization vector 415. In some implementations, the renderer 454 renders the VA(s), the XR content 427, one or more UI elements associated with the XR content, and/or the like according to the current camera pose relative thereto.

According to some implementations, the optional image processing architecture 462 obtains an image stream from an image capture device 370 including one or more images of the physical environment 105 from the current camera pose of the electronic device 120 and/or the user 150. In some implementations, the image processing architecture 462 also performs one or more image processing operations on the image stream such as warping, color correction, gamma correction, sharpening, noise reduction, white balance, and/or the like. In some implementations, the optional compositor 464 composites the rendered XR content with the processed image stream of the physical environment 105 from the image processing architecture 462 to produce rendered image frames of the XR environment 128. In various implementations, the presenter 470 presents the rendered image frames of the XR environment 128 to the user 150 via the one or more displays 312. One of ordinary skill in the art will appreciate that the optional image processing architecture 462 and the optional compositor 464 may not be applicable for fully virtual environments (or optical see-through scenarios).

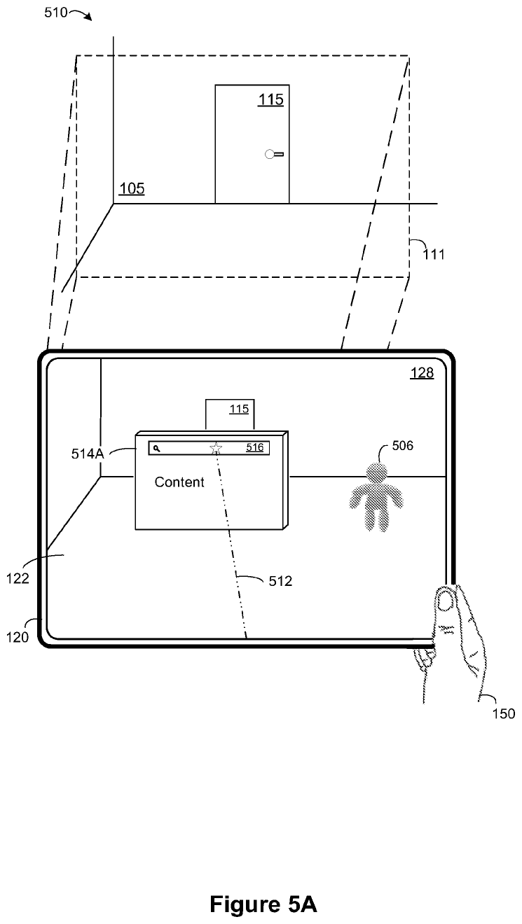

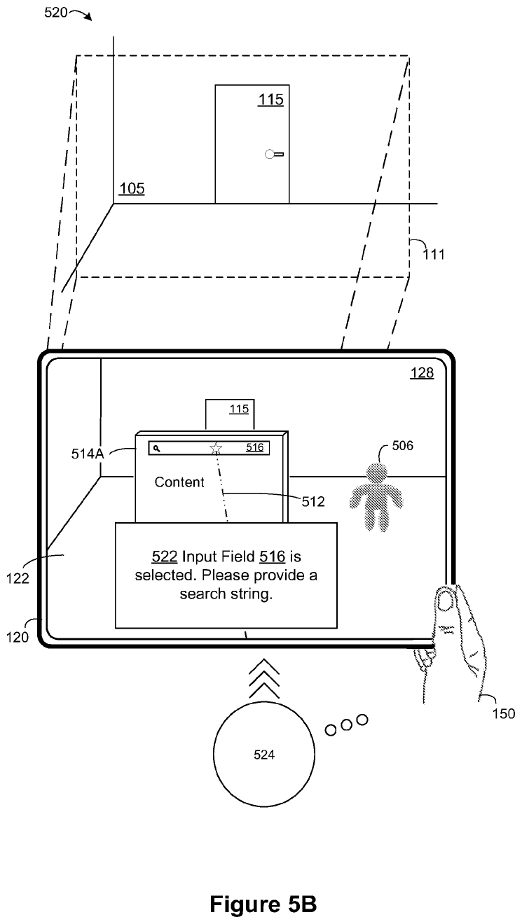

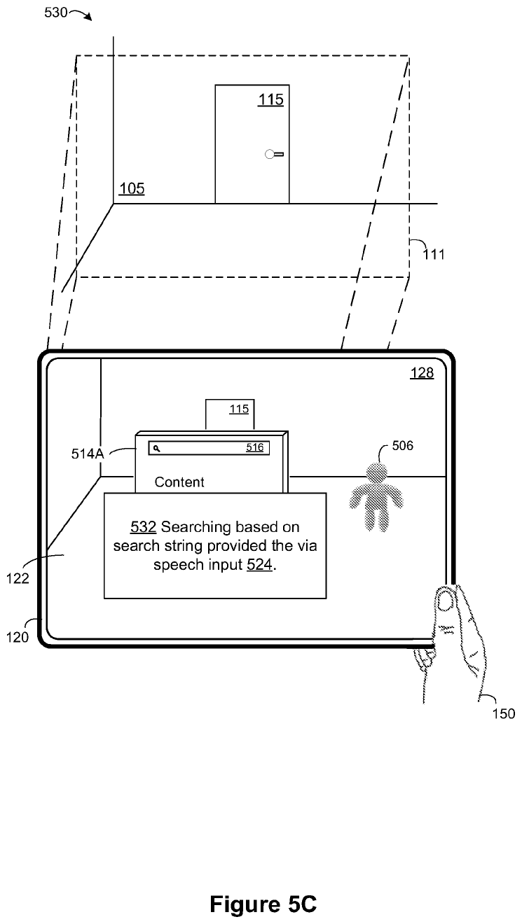

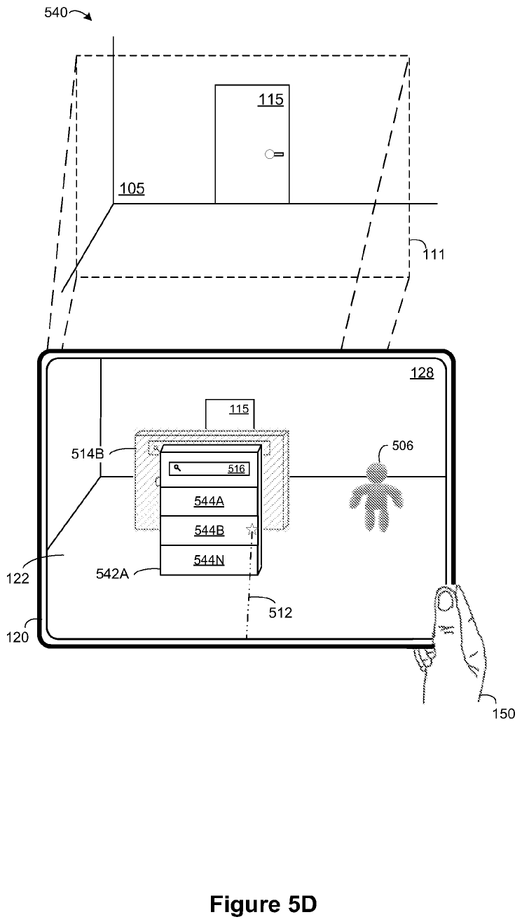

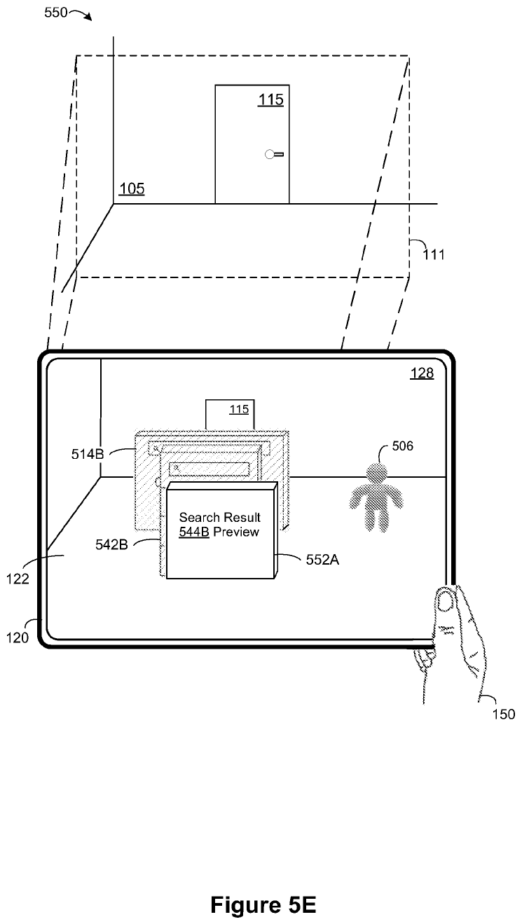

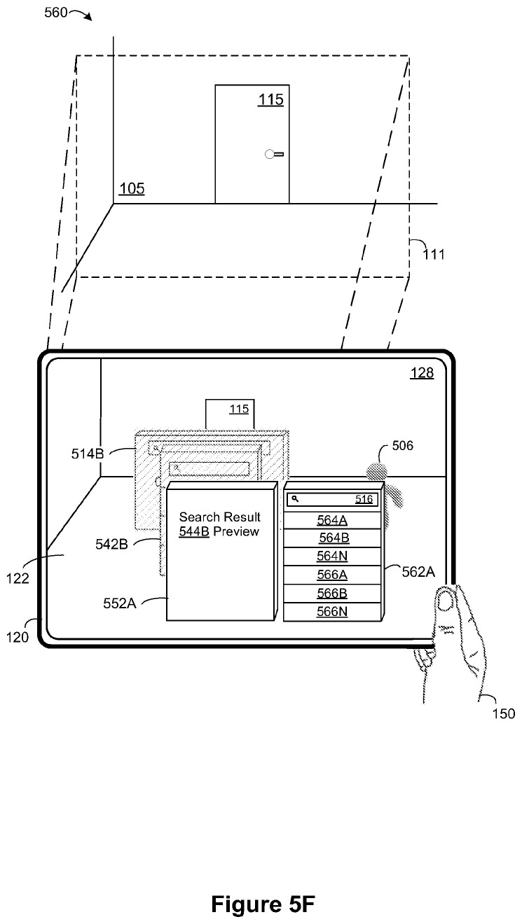

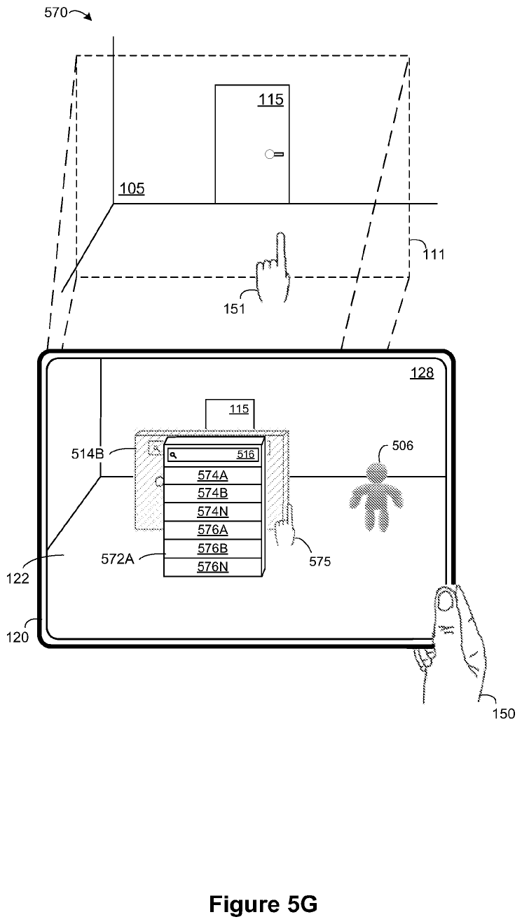

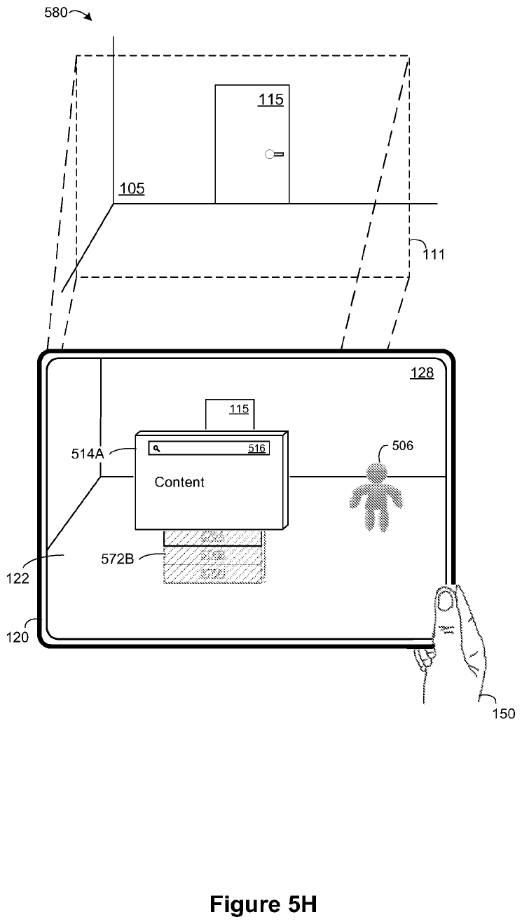

FIGS. 5A-5H illustrate a sequence of instances 510-580 for a content navigation scenario in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 510-580 are rendered and presented by a computing system such as the controller 110 shown in FIGS. 1 and 2: the electronic device 120 shown in FIGS. 1 and 3: and/or a suitable combination thereof.

As shown in FIGS. 5A-5H, the content navigation scenario includes a physical environment 105 and an XR environment 128 displayed on the display 122 of the electronic device 120 (e.g., associated with the user 150). The electronic device 120 presents the XR environment 128 to the user 150 while the user 150 is physically present within the physical environment 105 that includes a door 115, which is currently within the FOV 111 of an exterior-facing image sensor of the electronic device 120. As such, in some implementations, the user 150 holds the electronic device 120 in his/her hand(s) similar to the operating environment 100 in FIG. 1.

In other words, in some implementations, the electronic device 120 is configured to present XR content and to enable optical see-through or video pass-through of at least a portion of the physical environment 105 on the display 122 (e.g., the door 115). For example, the electronic device 120 corresponds to a mobile phone, tablet, laptop, near-eye system, wearable computing device, or the like.

As shown in FIG. 5A, during the instance 510 (e.g., associated with time T₁) of the content navigation scenario, the electronic device 120 presents an XR environment 128 including a virtual agent (VA) 506 and a first content pane 514A with a first appearance and a first z-depth value within the XR environment 128. In some implementations, the first appearance corresponds to a first translucency value, a first blur radius value, and/or the like. In FIG. 5A, the first content pane 514A includes an input field 516 (e.g., a search bar) and first content. In some implementations, the first content pane 514A is volumetric or three-dimensional (3D). For example, the first content pane 514A corresponds to a web browser window, an application window; and/or the like. Continuing with this example, the first content corresponds to text, image(s), video(s), audio, and/or the like. One of ordinary skill in the art will appreciate that the first content pane 514A is an example that may be modified in various other implementations.

As shown in FIG. 5A, the XR environment 128 also includes a visualization 512 of the gaze direction of the user 150 relative to the XR environment 128. One of ordinary skill in the art will appreciate that the visualization 512 may be modified or may not be displayed in various implementations. As shown in FIG. 5A, during the instance 510, the visualization 512 of the gaze direction of the user 150 is directed to the input field 516.

As shown in FIG. 5B, during the instance 520) (e.g., associated with time T₂) of the content navigation scenario, the electronic device 120 presents a notification 522 overlaid on the XR environment 128 in response to detecting the gaze direction of the user 150 directed to the input field 516 in FIG. 5A for at least a predetermined amount of time (e.g., X seconds). As shown in FIG. 5B, the notification 522 indicates that: “Input field 516 is selected. Please provide a search string.” One of ordinary skill in the art will appreciate that the notification 522 is an example that may be modified or may not be displayed in various other implementations. One of ordinary skill in the art will appreciate that the input field 516 may be selected via other input modalities, such as a touch input on the display 122, a speech input, a hand tracking input, and/or the like in various other implementations. As shown in FIG. 5B, during the instance 520) (e.g., associated with time T₂) of the content navigation scenario, the electronic device 120 detects a speech input 524 from the user 150 that corresponds to an input search string.

As shown in FIG. 5C, during the instance 530) (e.g., associated with time T₃) of the content navigation scenario, the electronic device 120 presents a notification 532 overlaid on the XR environment 128 in response to detecting the speech input 524 in FIG. 5B. As shown in FIG. 5C, the notification 532 indicates that the electronic device 120 is performing a search operation based on the input search string: “Searching based on search string provided via the speech input 524.” One of ordinary skill in the art will appreciate that the notification 532 is an example that may be modified or may not be displayed in various other implementations.

As shown in FIG. 5D, during the instance 540 (e.g., associated with time T₄) of the content navigation scenario, the electronic device 120 presents a second content second content plane 542A (sometimes also referred to herein as a “search pane”) with the first appearance and the first z-depth value within the XR environment 128 in response to performing the search operation based on the input search string provided via the speech input 524 in FIG. 5B. As shown in FIG. 5D, the second content plane 542A is overlaid on a first content pane 514B (e.g., a modified version of the first content pane 514A in FIG. 5A) with a second appearance and a second z-depth value within the XR environment 128. In some implementations, the second z-depth value is different from (e.g., greater than) the first z-depth value. In some implementations, the second appearance corresponds to a second translucency value, a second blur radius value, and/or the like, which are greater than the first translucency value, a first blur radius value, and/or the like associated with the first appearance.

In FIG. 5D, the second content plane 542A includes the input field 516 and a plurality of search results 544A, 544B, and 544N associated with the input search string provided via the speech input 524 in FIG. 5B. For example, the search results 544A, 544B, and 544N include media content, hyperlinks, and/or the like. In some implementations, the second content plane 542A is volumetric or 3D. One of ordinary skill in the art will appreciate that the second content plane 542A is an example that may be modified in various other implementations.

As shown in FIG. 5D, during the instance 540, the visualization 512 of the gaze direction of the user 150 is directed to the search result 544B within the second content plane 542A. One of ordinary skill in the art will appreciate that the visualization 512 may be modified or may not be displayed in various implementations.

In some implementations, in response to detecting selection of one of the search results 544A, 544B, and 544N within the second content plane 542A with a first input type (e.g., a speech input, touch input, hand tracking input, eye tracking input, or the like), the electronic device 120 ceases to display the second content plane 542A and presents content associated with the selected search result within the first content pane 514A with the first appearance and the first z-depth value within the XR environment 128. In some implementations, in response to detecting selection of one of the search results 544A, 544B, and 544N within the second content plane 542A with a second input type (e.g., a pinch and pull gesture, another gesture, or the like), the electronic device 120 may open an associated web page or display associated content in a new tab within a web browser application. In some implementations, in response to detecting selection of one of the search results 544A, 544B, and 544N within the second content plane 542A with a second input type (e.g., a pinch and pull gesture, another gesture, or the like), the electronic device 120 may open an associated web page or display associated content in a pane associated with a new stack or an existing stack of content panes. One of ordinary skill in the art will appreciate that the stacks of content panes may be configured similar to Provisional patent application No. 62/210,415, filed on Jun. 14, 2021 (Attorney Docket No. 27753-50477PR1), which is incorporated by reference herein in its entirety.

As shown in FIG. 5E, during the instance 550) (e.g., associated with time T₅) of the content navigation scenario, the electronic device 120 presents a preview pane 552A associated with the search result 544B in FIG. 5D with the first appearance and the first z-depth value within the XR environment 128 in response to detecting the gaze direction of the user 150 directed to the search result 544B within the second content plane 542A in FIG. 5D for at least the predetermined amount of time (e.g., X seconds). As shown in FIG. 5E, the preview pane 552A is overlaid on a second content pane 542B (e.g., a modified version of the second content plane 542A) with the second appearance and the second z-depth value. Furthermore, in FIG. 5E, the second content pane 542B is overlaid on the first content pane 514B with the second appearance and a third z-depth value. In some implementations, the third z-depth value is different from (e.g., greater than) the second z-depth value. For example, the preview pane 552A includes text, image(s), video(s), audio, and/or the like associated with the search result 544B in FIG. 5D. One of ordinary skill in the art will appreciate that the preview pane 552A is an example that may be modified or may not be displayed in various other implementations.

In some implementations, the second z-depth value associated with the second content pane 542B in FIG. 5E and the second z-depth value associated with the first content pane 514B in FIG. 5D correspond to a same z-depth value. In some implementations, the second z-depth value associated with the second content pane 542B in FIG. 5E and the second z-depth value associated with the first content pane 514B in FIG. 5D correspond to different z-depth values. In some implementations, the second z-depth value associated with the second content pane 542B in FIG. 5E and the second z-depth value associated with the first content pane 514B in FIG. 5D correspond to similar z-depth values within a predefined or deterministic offset of one another. In some implementations, the second z-depth value is greater when two panes are displayed within the XR environment 128 as in FIG. 5D than when more than two panes are displayed within the XR environment 128 as in FIG. 5E.

In some implementations, the second appearance associated with the second content pane 542B in FIG. 5E and the second appearance associated with the first content pane 514B in FIG. 5E correspond to a same appearance. In some implementations, the second appearance associated with the second content pane 542B in FIG. 5E and the second appearance associated with the first content pane 514B in FIG. 5E correspond to different appearances. As one example, the second appearance associated with the second content pane 542B in FIG. 5E may correspond to a second blur radius, a second color, a second texture, and/or the like that is different from the first appearance of the second content plane 542A in FIG. 5D. Continuing with this example, the second appearance associated with the first content pane 514B in FIG. 5E may correspond to a third blur radius, a third color, a third texture, and/or the like that is different from the first appearance of the first content pane 514A in FIG. 5A. In some implementations, the second appearance associated with the second content pane 542B in FIG. 5E and the second appearance associated with the first content pane 514B in FIG. 5E correspond to similar appearances within a predefined or deterministic tolerance of one another.

As shown in FIG. 5F, during the instance 560) (e.g., associated with time T₆) of the content navigation scenario, the electronic device 120 presents the preview pane 552A associated with the search result 544B in FIG. 5D with the first appearance and the first z-depth value within the XR environment 128 and a recommendation pane 562A with the first appearance and the first z-depth value within the XR environment 128 in response to a selection of the input field 516, such as by detecting the gaze direction of the user 150 directed to the search result 544B within the second content plane 542A in FIG. 5D for at least the predetermined amount of time (e.g., X seconds). As shown in FIG. 5F, the recommendation pane 562A includes: the input field 516: a plurality of content recommendations 564A, 564B, and 564N based on the search result 544B: and a plurality of search recommendations 566A, 566B, and 566N based on the search result 544B. For example, the plurality of content recommendations 564A, 564B, and 564N include media content, hyperlinks, and/or the like. For example, the plurality of search recommendations 566A, 566B, and 566N include media content, hyperlinks, and/or the like. One of ordinary skill in the art will appreciate that the recommendation pane 562A is an example that may be modified or may not be displayed in various other implementations.

As shown in FIG. 5F, the preview pane 552A and the recommendation pane 562A are overlaid on the second content pane 542B with the second appearance and the second z-depth value. Furthermore, in FIG. 5F, the second content pane 542B is overlaid on the first content pane 514B with the second appearance and the third z-depth value. In some implementations, the third z-depth value is different from (e.g., greater than) the second z-depth value.

In some implementation, in response to detecting selection of the second content pane 542B in FIG. 5E, the electronic device 120 ceases to display the preview pane 552A and displays both the second content plane 542A and the first content pane 514B closer to the user 150 (e.g., with the first z-depth value and the second z-depth value, respectively). In some implementation, in response to detecting selection of the first content pane 514B in FIG. 5E, the electronic device 120 ceases to display the preview pane 552A and the second content pane 542B and displays the first content pane 514A closer to the user 150 (e.g., with the first z-depth value). However, continuing with this example, in response to detecting a subsequent selection of the input field 516 within the first content pane 514A, the electronic device 120 displays the second content plane 542A overlaid on the first content pane 514B, wherein the second content plane 542A includes the same search results 544A, 544B, and 544N as in FIG. 5D.

As shown in FIG. 5G, during the instance 570 (e.g., associated with time T₇) of the content navigation scenario, the electronic device 120 presents a recommendation pane 572A overlaid on the XR environment 128 in response to detecting the gaze direction of the user 150 directed to the input field 516 in FIG. 5A for at least a predetermined amount of time (e.g., X seconds). As shown in FIG. 5G, the recommendation pane 572A includes: the input field 516: a plurality of content recommendations 574A, 574B, and 574N based on user preferences, search history, current context, etc.; and a plurality of search recommendations 576A, 576B, and 576N based on user preferences, search history, current context, etc. For example, the plurality of content recommendations 574A, 574B, and 574N include media content, hyperlinks, and/or the like. For example, the plurality of search recommendations 576A, 576B, and 576N include media content, hyperlinks, and/or the like. One of ordinary skill in the art will appreciate that the recommendation pane 572A is an example that may be modified or may not be displayed in various other implementations.

As shown in FIG. 5G, during the instance 570 (e.g., associated with time T₇) of the content navigation scenario, the electronic device 120 detects, via the body/head pose tracking engine 414, a hand tracking input with a left hand 151 of the user 150 directed to the first content pane 514B. In FIG. 5G, the electronic device 120 presents a representation 575 of the left hand 151 of the user 150 within the XR environment 128. One of ordinary skill in the art will appreciate that the hand tracking input with the left hand 151 of the user 150 is merely an example user input and that the electronic device 120 may detect various other input modalities such as speech inputs, touch inputs, eye tracking inputs, and/or the like.

As shown in FIG. 5H, during the instance 580) (e.g., associated with time T₈) of the content navigation scenario, the electronic device 120 presents the first content pane 514A with the first appearance and the first z-depth value within the XR environment 128 in response to detecting the hand tracking input with a left hand 151 directed to the first content pane 514B in FIG. 5G. As shown in FIG. 5H, the first content pane 514A is overlaid on a recommendation pane 572B (e.g., a modified version of the recommendation pane 572A) with a second appearance and a second z-depth value within the XR environment 128. In FIG. 5H, the first content pane 514A includes the input field 516 and the first content. In some implementations, in response to detecting the hand tracking input with a left hand 151 directed to the first content pane 514B in FIG. 5G, the electronic device 120 presents the first content pane 514A with the first appearance and the first z-depth value within the XR environment 128 and ceases to display the recommendation pane 572A/B.

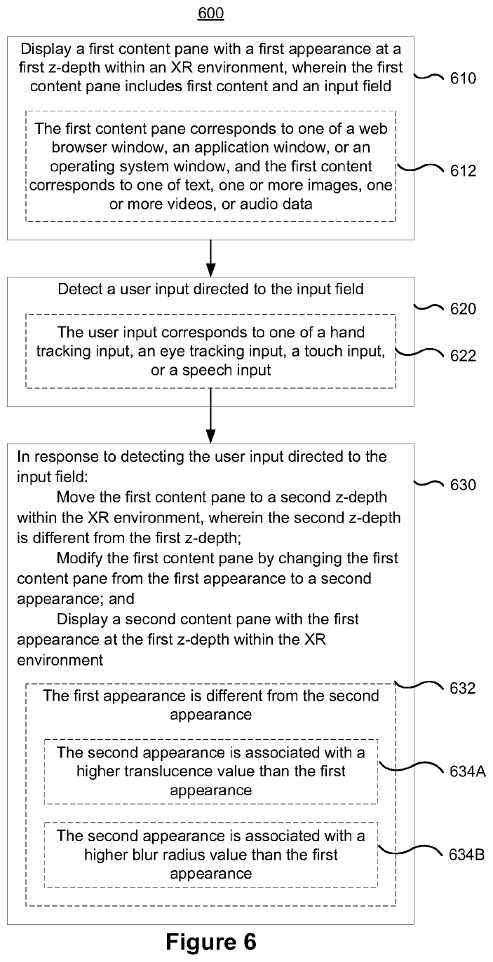

FIG. 6 is a flowchart representation of a method 600 of navigating windows in 3D in accordance with some implementations. In various implementations, the method 600 is performed at a computing system including non-transitory memory and one or more processors, wherein the computing system is communicatively coupled to a display device and one or more input devices (e.g., the electronic device 120 shown in FIGS. 1 and 3; the controller 110 in FIGS. 1 and 2; or a suitable combination thereof). In some implementations, the method 600 is performed by processing logic, including hardware, firmware, software, or a combination thereof. In some implementations, the method 600 is performed by a processor executing code stored in a non-transitory computer-readable medium (e.g., a memory). In some implementations, the computing system corresponds to one of a tablet, a laptop, a mobile phone, a near-eye system, a wearable computing device, or the like.

As discussed above, current web browsers may use a tab arrangement for open web pages and also provide a means for viewing browsing history. This organization structure makes it difficult to concurrently view past and present web pages and/or searches. While in an extended reality (XR) environment, a computing system content panes in z-depth where the panes are selectable/accessible via hand tracking inputs, eye tracking inputs, speech inputs, and/or the like. As such, in various implementations described herein, the selection of n input field (e.g., a search bar) within a first content pane causes the first content pane, including first content (e.g., a web page or other media), to be pushed backward in z-depth and a second content pane to be displayed at the former z-depth of the first content pane.

As represented by block 610, the method 600 includes displaying a first content pane with a first appearance at a first z-depth within an extended reality (XR) environment, wherein the first content pane includes first content and an input field. In FIG. 5A, for example, the electronic device 120 presents an XR environment 128 including a virtual agent (VA) 506 and a first content pane 514A with a first appearance and a first z-depth value within the XR environment 128. In some implementations, the first appearance corresponds to a first translucency value, a first blur radius value, and/or the like. In FIG. 5A, the first content pane 514A includes a input field 516 and first content. In some implementations, the first z-depth corresponds to a distance between the relative location for the first content pane within the XR environment in real-world coordinates and a location in real-world coordinates for one of the computing system, a viewpoint of a user associated with the computing system, the user associated with the computing system, a portion of the user associated with the computing system (e.g., a body part of the user, a viewpoint of the user, a midpoint between their eyes, the tip of the user's nose, a centroid associated with the user's head, a centroid associated with the user's face, etc.), and/or the like.

In some implementations, as represented by block 612, the first content pane corresponds to one of a web browser window, an application window, or an operating system window; and the first content corresponds to one of text, one or more images, one or more videos, or audio data. In some implementations, the first content pane is volumetric or three-dimensional (3D).

In some implementations, the first content pane is overlaid on the physical environment while displayed within the XR environment. As shown in FIG. 5A, for example, the first content pane 514A is overlaid on a video pass-through or optical see-through version of the physical environment 105.

In some implementations, the display device corresponds to a transparent lens assembly, and wherein the XR environment is projected onto the transparent lens assembly. In some implementations, the display device corresponds to a near-eye system, and wherein presenting the XR environment includes compositing the XR environment with one or more images of a physical environment captured by an exterior-facing image sensor. In some implementations, the XR environment corresponds to AR content overlaid on the physical environment. In one example, the XR environment is associated with an optical see-through configuration. In another example, the XR environment is associated with a video pass-through configuration. In some implementations, the XR environment corresponds a VR environment with VR content.

As represented by block 620, the method 600 includes detecting a user input directed to the input field. In FIG. 5A, for example, the electronic device 120 detects a gaze direction of the user 150 (e.g., associated with the visualization 512) directed to the input field 516 for at least a predetermined amount of time (e.g., X seconds). In some implementations, as represented by block 622, the user input corresponds to one of a hand tracking input, an eye tracking input, a touch input, or a speech input.

As represented by block 630, in response to detecting the user input directed to the input field, the method 600 includes: moving the first content pane to a second z-depth within the XR environment, wherein the second z-depth is different from the first z-depth; modifying the first content pane by changing the first content pane from the first appearance to a second appearance: and displaying a second content pane with the first appearance at the first z-depth within the XR environment. In FIG. 5D, for example, the electronic device 120 presents a second content plane 542A with the first appearance and the first z-depth value within the XR environment 128 in response to performing the search operation based on the input search string provided via the speech input 524 in FIG. 5B. As shown in FIG. 5D, the second content plane 542A is overlaid on a first content pane 514B (e.g., a modified version of the first content pane 514A in FIG. 5A) with a second appearance and a second z-depth value within the XR environment 128. In some implementations, the second z-depth value is different from the first z-depth value. In some implementations, the second appearance corresponds to a second translucency value, a second blur radius value, and/or the like, which are greater than the first translucency value, a first blur radius value, and/or the like associated with the first appearance. In some implementations, the second content pane at least partially overlaps the first content pane. In FIG. 5D, for example, the second content plane 542A is overlaid on and partially overlaps the first content pane 514B. In some implementations, the second z-depth corresponds to a distance between the relative location for the first content pane within the XR environment in real-world coordinates when displayed with the second appearance and a location in real-world coordinates for one of the computing system, a viewpoint of a user associated with the computing system, the user associated with the computing system, a portion of the user associated with the computing system (e.g., a body part of the user, a midpoint between their eyes, the tip of the user's nose, a centroid associated with the user's head, a centroid associated with the user's face, etc.), and/or the like.

In some implementations, as represented by block 632, the first appearance is different from the second appearance. In some implementations, as represented by block 634A, the second appearance is associated with a higher translucency value than the first appearance. In some implementations, as represented by block 634B, the second appearance is associated with a higher blur radius value than the first appearance. In some implementations, modifying the first content pane includes changing from the first appearance to a second appearance by blurring at least a portion of the first content pane. As one example, in FIG. 6D, the second content plane 542A is overlaid on a first content pane 514B (e.g., a modified version of the first content pane 514A in FIG. 5A) with the second appearance such as a higher translucency value of a higher blur radius value than the first appearance.

In some implementations, the second content pane includes at least one of: one or more previous search queries, one or more search recommendations, or one or more content recommendations based on at least one of one or more user preferences, a user search history, or current context. As one example, in FIG. 5G, the electronic device 120 presents a recommendation pane 572A overlaid on the XR environment 128 in response to detecting the gaze direction of the user 150 directed to the input field 516 in FIG. 5A for at least a predetermined amount of time (e.g., X seconds). As shown in FIG. 5G, the recommendation pane 572A includes: the input field 516: a plurality of content recommendations 574A, 574B, and 574N based on user preferences, search history, current context, etc.: and a plurality of search recommendations 576A, 576B, and 576N based on user preferences, search history, current context, etc. For example, the plurality of content recommendations 574A, 574B, and 574N include media content, hyperlinks, and/or the like. For example, the plurality of search recommendations 576A, 576B, and 576N include media content, hyperlinks, and/or the like.

In some implementations, the user input includes a search string provided via a virtual keyboard or a speech input. In some implementations, the second content pane includes at least one of: one or more search results, one or more search recommendations, or one or more content recommendations based on the search string. As one example, in FIG. 5D, the electronic device 120 presents a second content plane 542A with the first appearance and the first z-depth value within the XR environment 128 in response to performing the search operation based on the input search string provided via the speech input 524 in FIG. 5B. In FIG. 5D, the second content plane 542A includes the input field 516 and a plurality of search results 544A, 544B, and 544N associated with the input search string provided via the speech input 524 in FIG. 5B. For example, the search results 544A, 544B, and 544N include media content, hyperlinks, and/or the like.

In some implementations, the method 600 further includes: detecting a subsequent user input associated with selecting a respective search result among the one or more search results: and in response to detecting the subsequent user input: displaying a preview pane with the first appearance at the first z-depth within the XR environment, wherein the preview pane is associated with the respective search result; moving the first content pane to a third z-depth within the XR environment, wherein the third z-depth is different from the second z-depth: moving the second content pane to a fourth z-depth within the XR environment: and modifying the second content pane by changing the second content pane from the first appearance to the second appearance. In some implementations, the fourth z-depth value corresponds to a z-depth value that is different from the first z-depth value and less than the third z-depth value. In some implementations, the fourth z-depth value corresponds to the second z-depth value. For example, the subsequent user input corresponds to a gaze input directed to the respective search result for at least a predetermined amount of time such as X seconds. As another example, the subsequent user input corresponds to one of a touch input, speech input, hand tracking input, eye tracking input, gestural input, and/or the like. In some implementations, the preview pane at least partially overlaps the second content pane. In some implementations, the second content pane closes at least temporarily while the preview pane is presented.

As one example, in FIG. 5E, the electronic device 120 presents a preview pane 552A associated with the search result 544B in FIG. 5D with the first appearance and the first z-depth value within the XR environment 128 in response to detecting the gaze direction of the user 150 directed to the search result 544B within the second content plane 542A in FIG. 5D for at least the predetermined amount of time (e.g., X seconds). As shown in FIG. 5E, the preview pane 552A is overlaid on a second content pane 542B (e.g., a modified version of the second content plane 542A) with the second appearance and the second z-depth value. Furthermore, in FIG. 5E, the second content pane 542B is overlaid on the first content pane 514B with the second appearance and a third z-depth value. In some implementations, the third z-depth value is different from the second z-depth value. For example, the preview pane 552A includes text, image(s), video(s), audio, and/or the like associated with the search result 544B in FIG. 5D.

As another example, in FIG. 5F, the electronic device 120 presents the preview pane 552A associated with the search result 544B in FIG. 5D with the first appearance and the first z-depth value within the XR environment 128 and a recommendation pane 562A with the first appearance and the first z-depth value within the XR environment 128 in response to detecting the gaze direction of the user 150 directed to the search result 544B within the second content plane 542A in FIG. 5D for at least the predetermined amount of time (e.g., X seconds). As shown in FIG. 5F, the recommendation pane 562A includes: the input field 516: a plurality of content recommendations 564A, 564B, and 564N based on the search result 544B: and a plurality of search recommendations 566A, 566B, and 566N based on the search result 544B. For example, the plurality of content recommendations 564A, 564B, and 564N include media content, hyperlinks, and/or the like. For example, the plurality of search recommendations 566A, 566B, and 566N include media content, hyperlinks, and/or the like.

In some implementations, the method 600 further includes: detecting a subsequent user input associated with selecting the first content pane: and in response to detecting the subsequent user input: moving the first content pane to the first z-depth within the XR environment: moving the second content pane to the second z-depth within the XR environment: modifying the second content pane by changing the second content pane from the first appearance to the second appearance: and modifying the first content pane by changing the first content pane from the second appearance to the first appearance. In some implementations, the subsequent user input corresponds to one of a hand tracking input, an eye tracking input, a touch input, a gestural input, or a speech input. As one example, in FIG. 5H, the electronic device 120 presents the first content pane 514A with the first appearance and the first z-depth value within the XR environment 128 in response to detecting the hand tracking input with a left hand 151 directed to the first content pane 514B in FIG. 5G. As shown in FIG. 5H, the first content pane 514A is overlaid on a recommendation pane 572B (e.g., a modified version of the recommendation pane 572A) with a second appearance and a second z-depth value within the XR environment 128. In FIG. 5H, the first content pane 514A includes the input field 516 and the first content. Alternatively, in some implementations, the method 600 further includes: detecting a subsequent user input associated with selecting the first content pane: and in response to detecting the subsequent user input: ceasing to display the second content pane: and displaying the first content pane with the first z-depth within the XR environment.

In some implementations, the method 600 further includes: detecting a subsequent user input associated with manipulating the second content pane: and in response to detecting the subsequent user input, manipulating the second content pane based on the subsequent user input by at least one of: translating the second content pane, rotating the second content pane, scaling the second content pane, or modifying an appearance parameter of the second content pane. For example, the appearance parameter corresponds to one of a color, contrast, texture, brightness, etc. As one example, the user 150 may interact with the second content plane 542A in FIG. 5D with touch inputs, speech inputs, hand tracking inputs, eye tracking inputs, and/or the like in order to translate, rotate, scale, or otherwise modify the second content plane 542A in FIG. 5D. As another example, the user 150 may interact with the first content pane 514A shown in FIG. 5A with touch inputs, speech inputs, hand tracking inputs, eye tracking inputs, gestural inputs, and/or the like in order to translate, rotate, scale, or otherwise modify the first content pane 514A shown in FIG. 5A. As yet another example, the user 150 may interact with the preview pane 552A shown in FIG. 5E with touch inputs, speech inputs, hand tracking inputs, eye tracking inputs, gestural inputs, and/or the like in order to translate, rotate, scale, or otherwise modify the preview pane 552A shown in FIG. 5E.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first media item could be termed a second media item, and, similarly, a second media item could be termed a first media item, which changing the meaning of the description, so long as the occurrences of the “first media item” are renamed consistently and the occurrences of the “second media item” are renamed consistently. The first media item and the second media item are both media items, but they are not the same media item.

The terminology used herein is for the purpose of describing particular implementations only and is not intended to be limiting of the claims. As used in the description of the implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-25. (canceled)

26. A method comprising:
at a computing system including non-transitory memory and one or more processors, wherein the computing system is communicatively coupled to a display device and one or more input devices:
displaying a first content pane with a first appearance at a first z-depth within an extended reality (XR) environment, wherein the first content pane includes first content and an input field;
detecting a user input directed to the input field; and
in response to detecting the user input directed to the input field:
moving the first content pane to a second z-depth within the XR environment, wherein the second z-depth different from the first z-depth:
modifying the first content pane by changing the first content pane from the first appearance to a second appearance; and
displaying a second content pane with the first appearance at the first z-depth within the XR environment.

27. The method of claim 26, wherein the first appearance is different from the second appearance, and wherein the second z-depth is greater than the first z-depth.

28. The method of claim 27, wherein the second appearance is associated with a higher translucency value than the first appearance.

29. The method of claim 27, wherein the second appearance is associated with a higher blur radius value than the first appearance.

30. The method of claim 26, wherein modifying the first content pane includes changing from the first appearance to a second appearance by blurring at least a portion of the first content pane.

31. The method of claim 26, wherein the first content pane corresponds to one of a web browser window, an application window, or an operating system window, and wherein Preliminary Amendment 2 the first content corresponds to one of text, one or more images, one or more videos, or audio data.

32. The method of claim 26, wherein the first content pane is volumetric or three-dimensional (3D).

33. The method of claim 26, wherein the second content pane at least partially overlaps the first content pane.

34. The method of claim 26, wherein the second content pane includes at least one of: one or more previous search queries, one or more search recommendations, or one or more content recommendations based on at least one of one or more user preferences, a user search history, or current context.

35. The method of claim 26, wherein the user input includes a search string provided via a virtual keyboard or a speech input.

36. The method of claim 35, wherein the second content pane includes at least one of: one or more search results, one or more search recommendations, or one or more content recommendations based on the search string.

37. The method of claim 36, further comprising:
detecting a subsequent user input associated with selecting a respective search result among the one or more search results; and
in response to detecting the subsequent user input:
displaying content associated with the respective search result within the first content pane at the first z-depth within the XR environment, wherein the first content pane is associated the first appearance; and
ceasing to display the second content pane.

38. The method of claim 36, further comprising:
detecting a subsequent user input associated with selecting a respective search result among the one or more search results; and
in response to detecting the subsequent user input:
displaying a preview pane with the first appearance at the first z-depth within the XR environment, wherein the preview pane is associated with the respective search result:
moving the first content pane to a third z-depth within the XR environment, wherein the third z-depth is different from the second z-depth;
moving the second content pane to a fourth z-depth within the XR environment; and
modifying the second content pane by changing the search pane from the first appearance to the second appearance.

39. The method of claim 38, wherein the subsequent user input corresponds to one of a hand tracking input, an eye tracking input, a touch input, a gestural input, or a speech input.

40. The method of claim 26, further comprising:
detecting a subsequent user input associated with selecting the first content pane; and
in response to detecting the subsequent user input:
moving the first content pane to the first z-depth within the XR environment;
moving the second content pane to the second z-depth within the XR environment;
modifying the second content pane by changing the second content pane from the first appearance to the second appearance; and
modifying the first content pane by changing the first content pane from the second appearance to the first appearance.

41. The method of claim 26, further comprising:
detecting a subsequent user input associated with selecting the first content pane; and
in response to detecting the subsequent user input:
moving the first content pane to the first z-depth within the XR environment;
modifying the first content pane by changing the first content pane from the second appearance to the first appearance; and
ceasing to display the second content pane.

42. The method of claim 26, further comprising:
detecting a subsequent user input associated with manipulating the second content pane; and
in response to detecting the subsequent user input, manipulating the second content pane based on the subsequent user input by at least one of: translating the second content pane, rotating the second content pane, scaling the second content pane, or modifying an appearance parameter of the second content pane.

43. The method of claim 1, wherein the first z-depth corresponds to a distance between a relative location for the first content pane within the XR environment in real-world coordinates and a location in real-world coordinates for one of the computing system, a viewpoint of a user associated with the computing system, the user associated with the computing system, or a portion of the user associated with the computing system.

44. A device comprising:
one or more processors;
a non-transitory memory;
an interface for communicating with a display device and one or more input devices; and
one or more programs stored in the non-transitory memory, which, when executed by the one or more processors, cause the device to:
display a first content pane with a first appearance at a first z-depth within an extended reality (XR) environment, wherein the first content pane includes first content and an input field;
detect a user input directed to the input field; and
in response to detecting the user input directed to the input field:
move the first content pane to a second z-depth within the XR environment, wherein the second z-depth different from the first z-depth:
modify the first content pane by changing the first content pane from the first appearance to a second appearance; and
display a second content pane with the first appearance at the first z-depth within the XR environment.

45. A non-transitory memory storing one or more programs, which, when executed by one or more processors of a device with an interface for communicating with a display device and one or more input devices, cause the device to:
display a first content pane with a first appearance at a first z-depth within an extended reality (XR) environment, wherein the first content pane includes first content and an input field;
detect a user input directed to the input field; and
in response to detecting the user input directed to the input field:
move the first content pane to a second z-depth within the XR environment, wherein the second z-depth different from the first z-depth;
modify the first content pane by changing the first content pane from the first appearance to a second appearance; and
display a second content pane with the first appearance at the first z-depth within the XR environment.
